(19) United States
(12) Patent Application Publication
(10) Pub. No.: US 2009/0176638 A1
(43) Pub. Date: Jul. 9, 2009

(54) Gas sealed apparatus for separating solids, liquids and gases having different specific gravities

(76) Inventor: John Di Bella, Fort Lauderdale, FL (US)

Correspondence Address: OLTMAN, FLYNN & KUBLER, 915 MIDDLE RIVER DRIVE, SUITE 415, FORT LAUDERDALE, FL, 33304, US

(21) Appl. No.: 12/288,850

(22) Filed: Oct. 23, 2008

Related U.S. Application Data
(60) Provisional application No. 61/000,017, filed on Oct. 23, 2007.

(51) Int. Cl. B04B 15/08

(52) U.S. Cl. 494/39

(57) ABSTRACT

An axial flow-type pump apparatus with gas seals for separating immiscible flowable materials having different specific gravities and a discharge manifold connected to the fluid pump for drawing off the flowable material having the heavier specific gravity with greatly improved efficiency, and pump and apparatus longevity. The flowable material pump employs a rotatable impeller mechanism having a hollow core and a decreasing axial pitch in the direction of materials flow. The flowable materials are introduced into the inlet end of the rotatable impeller to produce a high velocity swirling action and a low pressure area along the longitudinal axis of the flow line, to generate a high centrifugal force as the flowable materials move axially and cause the flowable material having the heavier specific gravity to migrate to the perimeter while the lower specific gravity materials migrate to the center of the perimeter, whereupon they are separately discharged.

### FILING HISTORY

This application continues from provisional patent application Ser. No. 61/000,017 filed on Oct. 23, 2007.

### BACKGROUND OF THE INVENTION

1. Field of the Invention

The present invention relates generally to the field of devices for separating flowable material from immiscible fluid mixtures which can include solids, liquids and gases. Pariculate solids are also referred to as fluids in this application for convenience because they are a form of flowable material. More specifically the present invention relates to a gas sealed axial flow pump apparatus for separating immiscible fluids having different specific gravities, including separating particulate solids from liquids, and solids, from other particulate solids liquids from liquids, and gases from liquids. This apparatus is similar to the prior apparatus of applicant described in U.S. Pat. No. 5,084,189 issued on Jan. 28, 1992, except that the prior mechanical seals are replaced with gas seals.

The gas seals take the form of pressurized gas delivered into gaps between closely spaced moving parts surrounding a Voraxial mixture stream so that the flowable stream material cannot pass from within the Voraxial rotatable cylindrical drum to the bearings as a result of opposing gas pressure. As a result there is no contact friction such as from prior abutting mechanical seals, so that friction resistance to rotation is eliminated and much greater rotational speeds can be reached with high separation efficiency, and so that mechanical wear of seals is greatly reduced and the life of the separator apparatus is increased as much as ten fold or more.

The higher rotational speed increases the quantity of fluid processed and ultimately separated by the separator. The higher rotational speed virtually eliminates any potential pressure loss of the fluid passing through the separator and actually creates an increase in pressure.

This vast improvement discovered by applicant using gas seals has been entirely unrecognized in the materials separation industry. Applicant has found that gas sealing of the pump and spinning cylindrical drum increases the attainable cartridge rotational speed by as much as 3000 revolutions per minute (rpm), or greater. As a result, much larger centrifugal G-forces are developed in the composite fluid than have been possible with previous separators which significantly increases separation performance so that, not only liquids having different specific gravities, but liquids gases and particulate solids can be separated. Examples of mixture combinations of material phase components which can be separated from a mixture by the high speed gas sealed separator apparatus are:
Liquid/liquid
Liquid/solid
Liquid/liquid/solid
Liquid/solid/solid
Liquid/liquid/gas
Liquid/solid/gas
Liquid/liquid/solid/gas
Liquid/solid/solid/gas
Liquid/gas
   where solid/solid combinations are particulate solids moving within a flow stream.

2. Description of the Prior Art

There have long been separating devices for separating materials in mixtures having different specific gravities. Yet none have satisfactorily and economically separated particulate solids, liquids and/or gases from liquids without a pressure drop and with a small footprint, despite the need for such devices.

Separation of contaminants including solids, liquids and gases from a composite fluid stream is needed in virtually every industry such as petroleum, sewage, manufacturing and mining, to name a few. In the oil and gas industry, produced water comprises over 98% of the total volume of exploration and production wastewater produced in the United States. Produced water is the associated water that is produced along with oil and/or gas during normal production operations. Produced water is not a marketable product, so it must be disposed of (with this said, many companies are now seeking ways to purify the water to drinking water standards). Produced water may be contaminated with either oil, solids, gases or a combination thereof. In many land-based production operations, the produced water is either injected into a disposal well or is re-injected into a producing well to maintain reservoir pressure and enhance oil recovery. Produced water must be treated prior to re-injection because many of the components can be harmful to the formation or the associated piping. In the case of suspended oil associated with the produced water, it can be separated and sold to generate revenue for the facility.

Millions of gallons of diesel fuel and jet fuel are transported by ships to various parts of the world for refueling of planes at sea and for delivery to ports. These transport ships contain many compartments for holding the diesel and jet fuel. While the fuels are in these compartments, they may become contaminated with water. However, fuel contaminated with water is unsuitable for use. Thus, at the point of delivery, any fuel contaminated with water will be rejected, and must be returned to the point from which it was shipped for refinement. The re-transportation and refinement of the fuel is both costly and time consuming.

It is a purpose of my invention to provide a method and apparatus for separating fluids, solids and/or gases from a composite liquid stream.

Centrifugal separators for the separation of immiscible fluids of different specific gravities are well know. These centrifugal separators employ a rotor for rotating the mixture of fluids, causing the fluid having the lighter specific gravity to migrate to the center of the rotating mass, and the fluid having the heavier specific gravity to migrate to the perimeter, where it can be extracted. Examples of such centrifugal separators are disclosed in U.S. Pat. No. 4,478,712 to Arnaudeau, U.S. Pat. No. 3,517,821 to Monson et al., German patent No. 1,186,412 to Groppel, and Swiss patent No. 563,186 to Reynolds. Flow pumps and blowers built on the same general principle are disclosed in U.S. Pat. No. 1,071,042 to Fuller and U.S. Pat. No. 3,083,893 to Dean, respectively, and in my U.S. Pat. Nos. 3,276,382, 3,786,996, and 3,810,635.

However, none of these devices provides a sufficiently great G-force in a continuous flow and without a significant pressure drop to create a well-defined boundary between the fluids as they separate under centrifugal force, e.g. by forcing the fluid having the lighter specific gravity to a tight core in the center of a tube of the fluid having the heavier specific gravity, whereby the fluid having the heavier specific gravity can be drawn off in a single pass without the need for additional treatment of the fluid having the lighter specific gravity. Further, none of these devices provides an adjustable mechanism for drawing off the fluid having the heavier specific gravity. It is the solution of these problems to which the present invention is directed.

It is thus an object of the present invention to provide a method and apparatus for separating immiscible fluids having different specific gravities which greatly increases the gravitational force acting on the fluids by accelerating the swirl velocity of the fluids well beyond the capability of mechanically sealed devices while maintaining a high volume flow.

It is another object of this invention to provide a method and apparatus for separating immiscible fluids having different specific gravities with no contact friction at apparatus seals, so that much greater rotational speeds can be reached and with less energy input for high efficiency.

It is still another object of this invention to provide a method and apparatus capable of separating liquids, solids and/or gases from liquids and from each other in immiscible fluids having different specific gravities with only one treatment stage.

It is finally an object of the present invention to provide such a method and apparatus in which mechanical wear of seals is greatly reduced and the life of the apparatus is increased as much as ten fold or more.

### SUMMARY OF THE INVENTION

The present invention accomplishes the above-stated objectives, as well as others, as may be determined by a fair reading and interpretation of the entire specification.

The foregoing and other objects of the invention are achieved by provision of an axial flow-type pump having gas seals for separating immiscible fluids having different specific gravities and a discharge manifold connected to the fluid pump for drawing off the separated fluids, solids or gases. The fluid pump employs a rotatable impeller mechanism having a hollow core and a decreasing axial pitch in the direction of fluid flow. The fluid interface between the pump and the discharge manifold is adjustable, so that the discharge of the fluid having the heavier or lighter specific gravity can be adjusted.

The method according to the invention comprises introducing the fluids into the inlet end of a rotatable impeller in accordance with the invention, to produce a high velocity swirling action in the fluids and a low pressure area along the longitudinal axis of the flow line, to generate a high centrifugal force as the fluids move axially, thereby throwing the fluid having the heavier specific gravity to the perimeter, and using a discharge manifold in accordance with the invention to draw off the separated fluids, solids or gases.

A better understanding of the disclosed embodiments of the invention will be achieved when the accompanying detailed description is considered in conjunction with the appended drawings in which like reference numerals are used for the same parts as illustrated in the different figures.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a cross-sectional side view of a fluid axial flow type pump with gas seals in accordance with the present invention;

FIG. 2 is an elevational view of the pump of FIG. 1;

FIG. 3 is a right side elevational view of the pump of FIG. 1;

FIG. 4 is a top plan view of the pump of FIG. 1; and

FIG. 5 is a partial cross-sectional side view of the pump and discharge manifold of FIG. 1, showing the fluid vortex created by the pump and the manner in which the fluid and solids having a heavier specific gravity, and fluids and solids having a lighter specific gravity are drawn off at the discharge manifold;

Prior Art FIG. 6 is a cross-sectional side view of a fluid axial flow type pump with\ seals and discharge manifold in accordance with the present invention.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

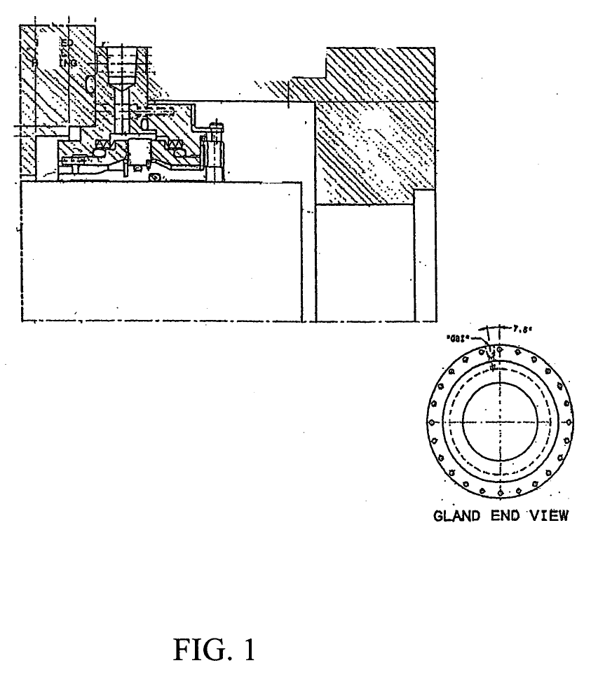

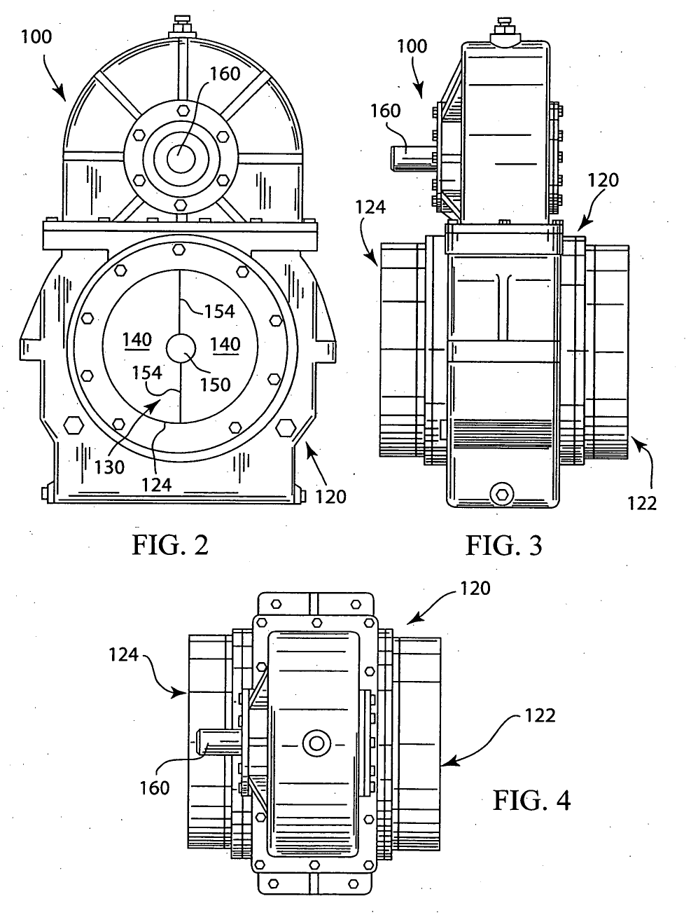

Referring to FIGS. 1-5, an apparatus 10 is disclosed for separating immiscible fluids having different specific gravities in accordance with the invention.

Separator 10 comprises a fluid flow device 100 of the axial pump type having gas seals, a discharge manifold 200, and an upstream discharge conduit 300 connecting fluid flow device 100 and discharge manifold 200. Discharge manifold 200 can be fluid connected to a downstream discharge conduit 400 for carrying the fluid having the lighter specific gravity. As illustrated in FIG. 1, axial pump 100 comprises fluid passage means such as a rotatable cylindrical drum or conduit 110 mounted for rotation in a housing 120 and having an inlet 122 and an outlet 124. Drum 110 provides a passage-way for the fluids.

Drum 110 is provided with an impeller or rotor 130 comprising helical blades 140 formed integrally with drum 110 to rotate with drum 110.

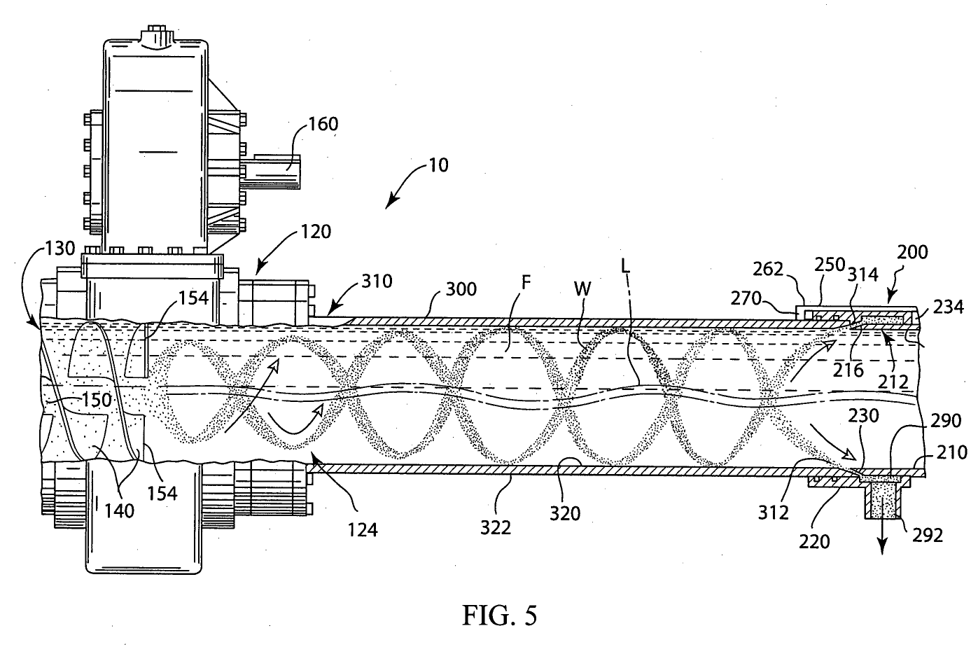

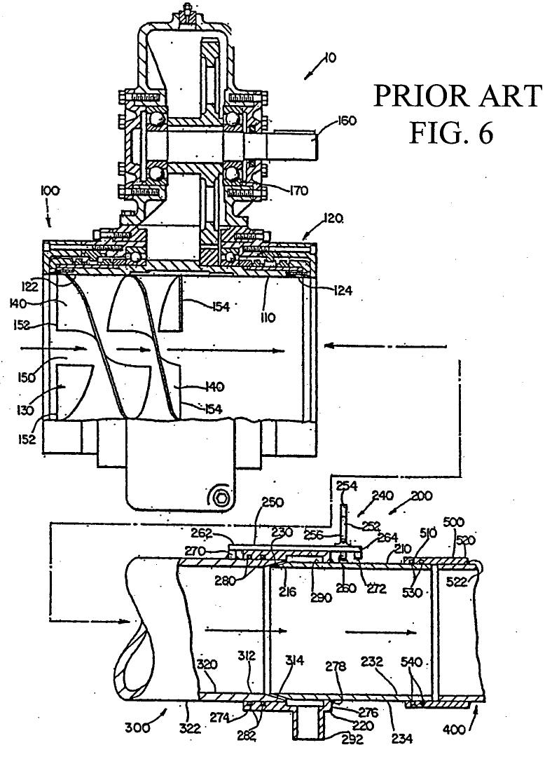

Blades 140 extend radially inwardly short of the longitudinal axis of drum 110 to provide or define an axial hollow core or opening 150. As blades 140 rotate, core 150 will initiate a low pressure area in the center of the flow line, with the high velocity, higher specific gravity fluid on the outer perimeter, as shown with respect to water W in FIG. 5, to provide an inherent separation of the fluids. Where the lower specific gravity fluid, solid or gas, L in FIG. 5, gets channeled to the center of the fluid stream while the higher specific gravity fluid, solid or gases, F in FIG. 5 gets channeled to the outside of the fluid stream again providing an inherent separation of the fluids.

Blades 140 have a higher axial pitch at their inlet ends 152 which is gradually reduced to a smaller axial pitch at their outlet ends 154. Preferably, blades 140 have an axial pitch of approximately ten inches at their inlet ends 152 and an axial pitch of approximately five inches at their outlet ends 154. Although these axial pitches will provide the desired volume and swirl velocity, they can be varied without departing from the spirit of the invention. These units are scalable in design and thus can be manufactured to various sizes to handle different flow rates.

Blades 140 will supply a flow volume of ten inch axial pitch, and as the helical pitch reduces to five inches, the swirl velocity increases greatly to provide a tight swirling axial movement of the fluids. With the reduction in pitch of blades 140, the swirl velocity and the centrifugal force are both doubled in comparison to blades of uniform pitch.

Because of their configuration, each of blades 140 is in contact with the fluids for a complete revolution. Continuous contact with the fluids for one complete revolution is necessary to change the swirl velocity and provide a smooth transition from low to high centrifugal action. Blades 140 also create less turbulence than, for example, shorter impeller blades would. This is a great advantage when one of the fluids is oil or another liquid which is easily emulsified, as the reduced turbulence will prevent emulsification.

Axial pumps such as pump 100 are normally powered and require a suitable power source such as a motor (not shown) for rotating an input shaft 160 drivingly connected to gearing 170. Suitable bearing means 180 must be employed for axially positioning and rotatably supporting drum 110 within housing 120. A detailed description of the structure associated with the drive mechanism for pump 100 can be found in my U.S. Pat. Nos. 3,786,996 and 3,810,635, which are specifically incorporated herein by reference, and made a part hereof as though reproduced herein, with respect to their descriptions of the structure associated with the drive mechanism for a pump.

Upstream discharge conduit 300 has an inlet end 310 and an outlet end 312. Inlet end 310 can be fluid connected by conventional means to the tank or other container holding the fluids to be separated, at the point of delivery of the fluids. Drum 110 is conventionally fluid connected at its outlet end 154 to the inlet end 310 of upstream discharge conduit 300. Outlet end 312 tapers outwardly, that is, its outer edge 314 tapers outwardly in the downstream direction from the inner surface 320 to the outer surface 322 of upstream discharge conduit 300, for a purpose to be described hereinafter. The angle of the taper, that is, the angle between edge 314 and outer surface 322 preferably is approximately 12 degrees, to obtain optimum results.

Discharge manifold 200 comprises an axially movable conduit section 210 having substantially the same inner diameter as drum 110, and having an inlet end 212 and an outlet end 214. An upstream seal 220 is affixed to conduit section 210 for sealingly connecting conduit section 210 at its inlet end 212 to the outlet end 312 of upstream discharge conduit 300, and permitting relative axial movement of conduit section 210 and upstream discharge conduit 300.

Inlet end 212 tapers outwardly, i.e., its outer edge 230 tapers outwardly in a downstream direction from the inner surface 232 to the outer surface 234 of conduit section 210 for mating engagement with tapered outer edge 314 of upstream discharge conduit 300. For this purpose, the angle formed between outer edge 230 and inner surface 232 of conduit section 210 is substantially the same as the angle formed between outer edge 314 and outer surface 322 of upstream discharge conduit 300.

An adjustment assembly 240 is provided for moving conduit section 210 into and out of engagement with outlet end 312 of upstream discharge conduit 300 for respectively closing and opening discharge manifold 200.

Adjustment assembly 240 comprises a platform 250 extending to discharge manifold 200 upstream of outlet end 312 of upstream seal. An operating handle 252 is provided for operating discharge manifold 200. Handle 252 has a distal end 254 extending outwardly from platform 250 and a proximal end 256 by which it is pivotally mounted to platform 250. A link 260 is pivotally mounted at one end to moveable conduit section 210 and pivotally mounted at the other end to proximal end 256 of handle 250 through a slot (not shown) in platform 250. As handle 252 is pivoted, its motion is transmitted to movable conduit section 210 through link 260. Thus, when handle 252 is pivoted towards upstream discharge conduit 300, movable conduit section 210 moves away from upstream discharge conduit 300 to open discharge manifold 200; and when handle 252 is rotated away from upstream discharge conduit 300, movable conduit section 210 moves away from upstream discharge conduit 300 to close discharge manifold 200, and upstream discharge conduit 300 Movable conduit section 210 can be fully engaged, fully disengaged, or any position in between, depending upon the amount handle 252 is rotated. A gauge (not shown) can be provided on platform 250 (e.g. at the slot) to indicate by the position of handle 252 what percentage discharge manifold 200 is open.

Platform 250 has an upstream end 262 and a downstream end 264. A first block 270 joins upstream end 262 to upstream discharge conduit 300 and also acts as a stop for discharge manifold 200 in it full closed position. A second block 272 extends downwardly from downstream end 264 of platform 250 and acts as a stop for discharge manifold 200 in the full open position.

Upstream gas seal has an upstream end 274 and a downstream end 276. Upstream end 274 seals outlet end 312 of upstream discharge conduit 300. Downstream end 276 is fixed to inlet end 212 of moveable 10 conduit section 210 upstream of link 260, e.g., by a weld 278.

Gas seals are provided between upstream end 274 relative to outlet end 312 of upstream discharge conduit 300. A circumferential discharge channel 290 is provided at downstream end 276 immediately adjacent the termination of the taper in edge 314 of upstream discharge conduit 300 to receive the fluid of lighter specific gravity circulating adjacent inner surface 320 of upstream discharge conduit 300 when discharge manifold 200 is open. A discharge port 292 opens into discharge channel 290 for receiving and discharging water from discharge channel 290.

Movable conduit section 210 is sealingly connected at its outlet end 214 to downstream discharge conduit 400 with a gas seal as shown in FIG. 1. Referring now to FIGS. 1 and 5, the operation of the invention will now be described with reference of the delivery of diesel or jet fuel from a transport ship, which fuel has been contaminated by sea water. However, it should be understood that application of the invention is not limited to the separation of water and fuel or to use in the context of fuel transport ships, but can be used for the separation of any two fluids having different specific gravities, e.g. oil and water where water is the primary fluid, sludge and treated water in a water purification system, or in reverse osmosis.

In operation, the fluids in their unseparated state are fed into inlet 122 of drum 110 using conventional means. As blades 140 rotate, the water W (which has a heavier specific gravity than the fuel L) swirls in a vortex adjacent the inner surface 320 of upstream discharge conduit 300. The fuel F as the primary fluid, occupies the entire flow line. It is noted that, if the water W were the primary fluid, the water W, which then becomes F in FIG. 5, would still migrate to the perimeter, but the low pressure initiated by hollow core 150 would cause the fuel, in this instance L (which has a lighter specific gravity) to be compressed into a tight core around the axis of upstream discharge conduit 300, as shown in dotted lines in FIG. 5. However, if the water W were the primary fluid, then discharge manifold 200 would be replaced by a different discharge manifold, which does not constitute a part of this invention.

With discharge manifold 200 in the full open position as shown in FIG. 5, the water W will flow between edge 314 of upstream discharge conduit 300 and edge 216 of movable conduit section 210 into discharge channel 290, and out through discharge port 292. The fuel F, separated from the water W, will continue to flow through discharge manifold 200 and out through downstream discharge conduit 400 to its destination.

Thus, it will be seen that the present invention provides a unique method for separating immiscible fluids having different specific gravities. While a preferred embodiment of the invention has been disclosed, it should be understood that the spirit and scope of the invention are to be limited solely by the appended claims, since numerous modifications of the disclosed embodiment will undoubtedly occur to those of skill in the art.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. An apparatus for separating immiscible fluids having different specific gravities, comprising:
a fluid flow device comprising an axial pump, said axial pump comprising fluid passage means and an inlet and an outlet;
a discharge manifold for separately draining immiscible fluids, comprising a conduit section, said discharge manifold having an inlet end and having an outlet end in fluid communication with said inlet end of said conduit section;
an upstream discharge conduit connecting said fluid flow device and said discharge manifold and an inlet end and an outlet end, said inlet end being in fluid communication with a container holding fluids to be separated;
an upstream gas seal positioned to said conduit section for sealingly connecting said conduit section at its inlet end to said outlet end of said upstream discharge conduit;
and a downstream discharge conduit in fluid communication with said discharge manifold for carrying the fluid among the several immiscible fluids having the lighter specific gravity.

2. The apparatus of claim 1, wherein said upstream gas seal has an upstream end and a downstream end, said upstream end sealing outlet end of said upstream discharge conduit.

3. The apparatus of claim 1, additionally comprising a housing, wherein said fluid passage means comprises one of a rotatable cylindrical drum and a conduit mounted for rotation in said housing, such that said drum provides a passage-way passage for the fluids.

4. The apparatus of claim 1, wherein said drum has a longitudinal axis and comprises one of an impeller and a rotor, and at least one helical blade within and joined to said drum to rotate with drum.

5. The apparatus of claim 4, wherein said at least one blade extends radially inwardly within said drum and terminates short of the longitudinal axis of said drum to provide an axial hollow core, such that as said at least one blade rotates, said core initiates a low pressure area substantially in the center of the flow line, with high velocity, higher specific gravity fluid on the outer perimeter, to provide separation of the fluids,
where the lower specific gravity fluid is channeled to the center of the fluid stream while the higher specific gravity fluid is channeled to the outside of the fluid stream.

6. The apparatus of claim 5, wherein said at least one blade have a higher axial pitch at its inlet end which is gradually reduced to a smaller axial pitch at its outlet end.

7. The apparatus of claim 6, wherein said at least one blade has an axial pitch of substantially ten inches at its inlet end and an axial pitch of substantially five inches at its outlet end.

8. An apparatus for separating immiscible fluids having different specific gravities, comprising:
a fluid flow device comprising an axial pump having gas seals, said axial pump comprising fluid passage means and an inlet and an outlet;
and a discharge manifold for separately draining immiscible fluids, comprising conduit section and having an inlet end and an outlet end.

9. An apparatus for separating a fluid having a lighter specific gravity from a fluid having a heavier specific gravity comprising:
fluid passage means for receiving the fluids to be separated and having an inlet and an outlet and a longitudinal axis;
a discharge conduit connected to said outlet;
rotatable impeller means positioned in said fluid passage means for imparting a swirling axial movement to the fluids in said fluid passage means downstream of said impeller means in said discharge conduit and causing the fluid having the heavier gravity to migrate outwardly; and
discharge means connected to said discharge conduit for discharging the fluid having the lighter specific gravity separately from the fluid having the heavier specific gravity;
said impeller means comprising at least one helical blade each having an inlet end and an outlet end, said helical blade having a greater axial pitch at said inlet end than at said output end, and said helical blade terminating short of said longitudinal axis of said fluid passage means to define a hollow core through which the fluids pass;
an axially rotatable drum having axial drum ends, said fluid passage means forming part of said rotating drum, and said helical blade being integral with and extending from said fluid passage means;
and at least one gas seal between said rotatable drum and said discharge conduit.
